(19) United States
(12) Patent Application Publication
(10) Pub. No.: US 2003/0226298 A1
(43) Pub. Date: Dec. 11, 2003

(54) Bottle neck identification ring and method

(76) Inventor: Karl Andrew Bjork, Westboro, MA (US)

Correspondence Address: Kevin S. Lemack, Nields & Lemack, 176 E. Main Street, Westboro, MA, 01581, US

(21) Appl. No.: 10/166,875

(22) Filed: Jun. 11, 2002

(51) Int. Cl. G09F 3/00

(52) U.S. Cl. 40/310

(57) ABSTRACT

A closed, unbroken ring having an identifying member attached thereto, the ring having elasticity for placement on the free end of a bottle neck, and a method of distinguishing a plurality of bottles from one another by placing respective closed rings with distinctive ornamentation on the necks of each of the plurality of bottles.

### BACKGROUND OF THE INVENTION

The present invention relates to a beer bottle ring and method for marking beer bottles to distinguish one from another.

Decorative devices for display on a wine bottle and removal therefrom for placing on the stem of wine glasses to distinguish one wine glass from another are known. For example, U.S. Pat. No. 6,293,034 discloses a wine bottle ring of a continuous unbroken form for accepting a neck of a wine bottle. The wine bottle ring stores a plurality of wine glass rings, each providing a distinctive ornamentation, that are removably placed on the wine bottle ring. Each wine glass ring does not form a closed loop and thus can be removed from the wine bottle ring and can be spread opened to enclose the stem of a wine glass and be supported on the base of the glass. Since each wine glass ring has distinctive ornamentation attached to it, each wine glass can be distinguished from another. However, since the size of the wine glass rings is relatively small, their versatility is limited.

At social events and the like, beverages including beer, ale, lager, lemonade, soft drinks, etc. are often served in containers designed for individual consumption. Typically such containers are glass or plastic bottles that contain 12 ounces of liquid, and are shaped to have a relative thin neck portion that expands to a relative wide base. Although different brands of beverages are readily distinguishable by their labeling, it is often the case that more than one individual will be consuming the same brand of beverage. Under such circumstances, the containers may be commingled, resulting in one individual drinking from another individual's container. The wine glass rings of the '034 patent mentioned above cannot be used for such containers, since there is no central or “source” container analogous to the wine bottle on which the wine glass rings can be stored, and since such containers do not have a stem onto which the wine glass rings can be placed.

It is therefore an object of the present invention to provide a device and method for easily distinguishing conventional beer bottles and the like from one another.

It is a further object of the present invention to provide a device for distinguishing conventional beer bottles and the like from one another that is easily removable from the bottle and capable of being washed and re-used, yet remains secured to the bottle when the bottle is inverted during pouring or drinking.

These and other objects will be made apparent by reference to the following description and drawings.

### SUMMARY OF THE INVENTION

The problems of the prior art have been overcome by the present invention, which provides a closed, unbroken ring having an identifying member attached thereto, the ring having elasticity for placement on the free end of a bottle neck, and a method of distinguishing a plurality of bottles from one another by placing respective closed rings with distinctive ornamentation on the necks of each of the plurality of bottles.

### BRIEF DESCRIPTION OF THE DRAWINGS

FIG. 1 is a top view of a bottle ring having ornamentation in accordance with the present invention; and

FIG. 2 is a perspective view of a bottle having the bottle ring of FIG. 1 in accordance with the present invention.

### DETAILED DESCRIPTION OF THE INVENTION

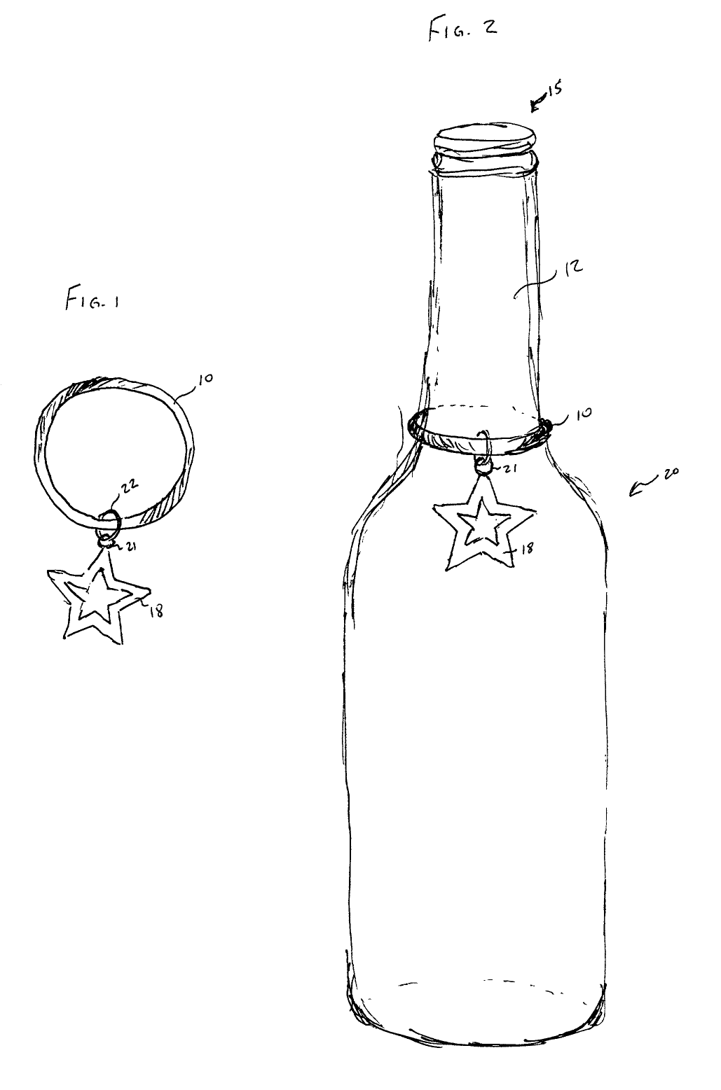

Turning now to FIGS. 1 and 2, there is shown a closed-loop bottle ring 10 in accordance with the present invention. The ring 10 has elasticity and memory so that it can be stretched to fit around the neck 12 of a bottle 20, and once so placed, tightly fits around the neck 12 so that it remains stable. In this regard, conventional beer bottles are typically formed with long necks that taper outwardly from the top open end towards the bottle base. Preferably the inside diameter of the ring 10, when in its normal unstretched state, is slightly smaller than the outside diameter of the smallest portion of the neck 12 of the bottle, so that when placed on the bottle neck, the ring 10 circumscribes the neck 12 and is tightly wrapped around the neck 12. However, it is within the scope of the present invention for the inside diameter of the ring 10, when in its normal unstretched state, to be the same as or slightly smaller than the outside diameter of any portion of the neck 12. It is also within the scope of the present invention to use the device on bottles other than beer bottles, although beer bottles will be used herein for purposes of illustration. Most preferably the bottles have elongated necks with a maximum outside diameter smaller than the maximum outside diameter of the bottle base. The bottles may be made of any suitable material, including glass and plastic.

The elasticity and memory of ring 10 allows it to remain secure on the neck 12 when the bottle is tilted or inverted, such as during pouring or drinking of the bottle contents. This is accomplished by the ring 10 contracting from its stretched state about the bottle neck. The contraction need to be complete to its original unstretched state; contraction to an intermediate state wherein the ring diameter is larger than the unstretched state but small enough to remain secure about the neck 12 when the bottle is tilted or inverted is sufficient and within the scope of the present invention.

Preferably the ring 10 is circular and is an O-ring, commercially available from numerous sources. Suitable ring materials include rubber (natural or synthetic), such as butadiene-styrene copolymers (SBR), acrylonitrilebutadiene copolymers, ethylenepropylene-diene rubbers (EPDM), butyl rubber, nitrile-butadiene rubber (NBR), chloroprene (Neoprene); silicone; urethane; polyacrylonitrile; tetrafluoroethylene fluorocarbon polymers (TEFLON) and combinations thereof. Other suitable materials include metal and plastic. Preferably a material is chosen that is durable and that can be washed in a conventional automatic dishwasher without destroying the material or its properties.

The ring 10 should have a sufficient inside diameter so that when placed on the neck 12 of a beer bottle 20 or the like, it remains stationary and compressed about the neck 12 even if the bottle is tilted or inverted. Suitable inside diameters are from about 1 inch to about 1.5 inches, preferably about 1.25 inches. The thickness of the wall defining the ring 10 is not particularly limited, but is preferably about 1/16″ to about ¼″, most preferably about ⅛″. Preferably the wall is circular in cross-section, although other shapes, regular or irregular, are within the scope of the invention.

The elasticity and memory of the ring 10 allows the ring 10 to be stretched to an inside diameter larger than the outside diameter of the bottle neck as it is placed over the open or free end 15 of the bottle neck 12, regardless of whether the bottle is capped or uncapped. The ring 10 (either while being stretched or after being allowed to return to its normal configuration) can then be pushed down the neck 12 to engage the neck 12 at a suitable resting location that is visible to the user as shown in FIG. 2. Once the beverage in the bottle is consumed and the bottle is to be discarded, the ring 10 can be removed from the bottle neck 12 by lifting it over and off the neck. If the ring 10 and/or identifying member 18 is soiled, the ring 10 and/or identifying member 18 can be washed and re-used. Alternatively, the ring and/or identifying member can be discarded.

In a preferred embodiment of the present invention, the ring 10 supports on or more identifying members 18. The design of each identifying member 18 is not particularly limited. In the embodiment shown, the identifying member 18 is an ornamental star, but those skilled in the art will appreciate that any figure or shape having any color or size could be used, provided that when the identifying member 18 is supported by ring 10 that is placed on a bottle neck 12, it distinguishes the bottle 12 from another bottle having a ring 10 supporting a different identifying member 18. For example, the identifying member could be a configuration identifying a particular hobby or of the user, such as a tennis racket, a golf club or a football, or could be in the configuration of a favorite pet or the like. The materials of construction of the identifying member 18 are not particularly limited, and include metal, ceramic, plastic, stone, shell, wood, etc. or combinations of the foregoing. The identifying member may be purely decorative, or may include functionality, such as a written message, an indication of the contents of the bottle, or an identifying brand mark. The function of a written message, inscription, annotation or brand allows the device to be useful in a kitchen, laboratory or other such setting where bottles are used to store consumable or useful liquids. The device also may be electronic, e.g., sending a sound pulse or tone, or a visual light emission. Such an electronic device may be triggered or activated by a remote activator device via infrared light or radio waves, for example.

The identifying member 18 can be supported by the ring 10 by any suitable means. Preferably a ring 22 having an inside diameter greater than the outside diameter of the wall of the ring 10 is positioned on the wall of the ring 10 and is attached to the identifying member 18 (such as through loop 21), so that the identifying member 18 is loosely attached to the ring 10. The ring 22 is a resilient material such as spring steel and is similar to conventional key rings used to attach keys to a key chain. Thus, the ring 22 can be opened to place it on or remove it from ring 10, or to attach identifying member 18 through the aperture in loop 21. Alternatively, the identifying member 18 can be permanently affixed to the ring 10 by fastening, gluing, etc. The identifying member 18 can be configured to also circumscribe the bottle.

In an alternative embodiment, the ring 10 itself is the identifying member. This can be accomplished by designing the rings to have different colors patterns, shapes, and/or inscriptions, etc., and/or be made of different materials, so that each ring of a set is distinctive.

What is claimed is:

1. A bottle identifying device adapted to circumscribe the neck of a bottle, comprising a closed loop elastic member having a first inside diameter in an unstretched state and a second inside diameter in a stretched state, said second inside diameter being greater than said first inside diameter and greater than the outside diameter of said neck of said bottle, said elastic member adapted to remain secured about said neck when said bottle is tilted; and an identifying member supported on said elastic member.

2. A plurality of bottles and a plurality of identifying devices for distinguishing each of said plurality of bottles one from another, each of said plurality of bottles having a neck, each of said plurality of identifying devices circumscribing a neck of a respective bottle and comprising:
a closed loop elastic member having a first inside diameter in an unstretched state and a second inside diameter in a stretched state, said second inside diameter being greater than said first inside diameter and greater than the outside diameter of said bottle neck, said elastic member adapted to remain secured about said neck when said bottle is tilted;
each of said elastic members having a distinctive feature for visually distinguishing each respective bottle.

3. The plurality of bottles and plurality of identifying devices of claim 2, wherein said distinctive feature comprises a distinctive identifying member supported on said elastic member.

4. The plurality of bottles and plurality of identifying devices of claim 2, wherein each of said plurality of bottles is a beer bottle.

5. The plurality of bottles and plurality of identifying devices of claim 2, wherein said elastic member is in an intermediate state having an inside diameter greater than said first inside diameter and smaller than said second inside diameter when secured about said neck.

6. A method of distinguishing one bottle from another, comprising:
providing a plurality of bottles each having a neck;
providing a plurality of closed loop elastic members each having a first inside diameter in an unstretched state and a second inside diameter in a stretched state, said second inside diameter being greater than said first inside diameter and greater than the outside diameter of a respective bottle neck, and a distinctive identifying member supported on said elastic member;
stretching each said elastic member and placing each stretched member on a respective bottle neck such that said distinctive identifying member visually distinguishes each respective bottle; and
allowing each said elastic member to contract about said neck to said unstretched state or to an intermediate state smaller than said stretched state but larger than said unstretched state, so as to remain secure about said neck even when said bottle is tilted.
